(19) United States
(12) Patent Application Publication
(10) Pub. No.: US 2014/0320698 A1
(43) Pub. Date: Oct. 30, 2014

(54) SYSTEMS AND METHODS FOR CAPTURING PHOTO SEQUENCES WITH A CAMERA

(71) Applicant: MICROSOFT CORPORATION, Redmond, WA (US)

(72) Inventors: Sathyanarayanan Karivaradaswamy, Sammamish, WA (US); Sang Choe, Redmond, WA (US); Li Li, Seattle, WA (US); Radhika Jandhyala, Redmond, WA (US); Mathieu Maitre, Redmond, WA (US)

(73) Assignee: Microsoft Corporation, Redmond, WA (US)

(21) Appl. No.: 13/872,374

(22) Filed: Apr. 29, 2013

(51) Int. Cl. H04N 5/76; H04N 5/232

(52) U.S. Cl. CPC H04N 5/76; H04N 5/23293
USPC 348/231.99

(57) ABSTRACT

Systems and methods providing a photo sequence mode for a camera system are provided. In one embodiment, a camera system comprises a camera, a controller and a camera driver. The camera system may be a part or subsystem of a smart device, a mobile device, a tablet, a laptop, a camera or the like. The photo sequence mode is capable of affecting image capture for a camera system that may have a slower response time that the most advanced digital camera (e.g. one that has a relatively small latency period between the time the user “clicks” the camera and the time the image is captured). In photo sequence mode, the camera system may set up prior to click indication. For example, pre-click or pre-processing image buffers may be allocated, image sensor may be warmed up and pre-click images may be stored in a limited number of pre-processing buffers.

### BACKGROUND

Taking photos and/or video using cameras on mobile and/or smart devices has become prevalent. These cameras may come with a number of advanced features. However, taking a timely picture with these cameras may have its own set of challenges. A few aspects may arise due to significant delays in propagating user's click to the device, long post processing and long rendering of encoded high resolution photos. These delays may cause the user to miss capturing the intended moment.

### SUMMARY

The following presents a simplified summary of the innovation in order to provide a basic understanding of some aspects described herein. This summary is not an extensive overview of the claimed subject matter. It is intended to neither identify key or critical elements of the claimed subject matter nor delineate the scope of the subject innovation. Its sole purpose is to present some concepts of the claimed subject matter in a simplified form as a prelude to the more detailed description that is presented later.

Systems and methods providing a photo sequence mode for a camera system are provided. In one embodiment, a camera system comprises a camera, a controller and a camera driver. The camera system may be a part or subsystem of a smart device, a mobile device, a tablet, a laptop, a camera or the like. The photo sequence mode is capable of affecting image capture for a camera system that may have a slower response time that the most advanced digital camera (e.g. one that has a relatively small latency period between the time the user “clicks” the camera and the time the image is captured). In photo sequence mode, the camera system may set up prior to click indication. For example, pre-click or pre-processing image buffers may be allocated, image sensor may be warmed up and pre-click images may be stored in a limited number of pre-processing buffers.

In one embodiment, a method for providing a photo sequence mode for a camera system is disclosed, said camera system comprising a controller, a camera driver, a set of image buffers and an image capture sensor, the method comprising: allocating a desired number of pre-processing image buffers; receiving image data from a sensor; storing said image data into said pre-processing image buffers; re-using said pre-processing image buffers when said desired number of pre-processing image buffers have been filled; receiving a click indication; and storing image data into post-click image buffers after receiving said click indication.

In another embodiment, a camera system is provided comprising: a controller; a camera, said camera comprising an optical system, an image sensor; a camera driver, said camera driver executing on said controller and capable of controlling said camera; and further wherein said camera driver capable of: allocating a desired number of pre-processing image buffers; receiving image data from a sensor; storing said image data into said pre-processing image buffers; re-using said pre-processing image buffers when said desired number of pre-processing image buffers have been filled; receiving a click indication; and storing image data into post-click image buffers after receiving said click indication.

Other features and aspects of the present system are presented below in the Detailed Description when read in connection with the drawings presented within this application.

### BRIEF DESCRIPTION OF THE DRAWINGS

Exemplary embodiments are illustrated in referenced figures of the drawings. It is intended that the embodiments and figures disclosed herein are to be considered illustrative rather than restrictive.

FIG. 1 depicts one embodiment of a camera driver/system in made in accordance with the principles of the present application

FIG. 2 shows one embodiment of a photo sequence mode of operation of a camera system, such as provided for example in FIG. 1.

FIG. 3 is one embodiment of a method in flowchart form of a camera driver/system affecting photo sequence mode.

FIG. 4 depicts another embodiment of the present system in a block diagram format.

### DETAILED DESCRIPTION

As utilized herein, terms “component,” “system,” “interface,” “controller” and the like are intended to refer to a computer-related entity, either hardware, software (e.g., in execution), and/or firmware. For example, any of these terms can be a process running on a processor, a processor, an object, an executable, a program, and/or a computer. By way of illustration, both an application running on a server and the server can be a component and/or controller. One or more components/controllers can reside within a process and a component/controller can be localized on one computer and/or distributed between two or more computers.

The claimed subject matter is described with reference to the drawings, wherein like reference numerals are used to refer to like elements throughout. In the following description, for purposes of explanation, numerous specific details are set forth in order to provide a thorough understanding of the subject innovation. It may be evident, however, that the claimed subject matter may be practiced without these specific details. In other instances, well-known structures and devices are shown in block diagram form in order to facilitate describing the subject innovation.

### GLOSSARY

The following is a listing of terminology that may be used in the current application.

| Technical Term | Description |
|---|---|
| Photo Sequence | Returning a sequence of photos - e.g., for a single |
| | (or small number) click(s) by the user. |
| TimeStamp | The time tag place on an entity marking that entity's |
| | creation in the system. For example, a photo sample's |
| | creation time. |
| Power Usage | The system usage to perform operations on the capture |
| | photos. This may translate into battery power usage |
| | of the system. |
| Photo Trigger | A command sent down to the photo capture hardware |
| | to inform the intent of user to start capturing |
| | the photos. |
| Photo Thumbnail | A smaller version of the photo. |
| AvStream | Audio Video Class driver. |
| Post - | The raw photo captured from the camera sensor that |
| Processing | may not be directly usable by applications. This image |
| | may get processed by the capture pipeline of the |
| | hardware and system to enhance the raw image to a |
| | user usable image. Such processing may comprise |
| | post processing. Post processing may involve one |
| | or more (or additional processes not listed below): |
| | 1. Color conversion |
| | 2. Scaling |
| | 3. Sharpening |
| | 4. Noise reduction |
| | 5. Image enhancements |
| | 6. Stabilization of the scenes |
| | 7. Lens corrections |
| | 8. Zooming |
| | 9. Panning etc . . . |

### INTRODUCTION

In several embodiments of the present application, systems, techniques and methods for continuously capturing images from a camera are presented herein. In many embodiments, a camera system, taking a sequence of photos, may designate a photo frame that the user intended by matching the user click's timestamp with the captured photo frame's timestamp. In other embodiments, there are also provided mechanisms with which users may capture frames before and after the user click that makes sure key moments are not lost while taking a picture.

In other embodiments, it may be desirable to reduce the rendering time of captured images and give the user substantially immediate feedback. In such embodiments, it is possible to provide uncompressed, scaled down versions of final photos before delivering actual (possibly compressed) full resolution photos. Applications may use and supply the scaled down uncompressed photo immediately to the user, thus reducing the delay in showing the captured photo to user. This mechanism of delivering unique services—e.g., supplying a scaled down photo early to an application (or user) tends to affect a way to perform the actual time consuming encoding of the final full resolution photo in the background in parallel to subsequent photo captures. This mechanism helps to remove any perceived delay in photo taking on less-expensive camera systems found on e.g., smart devices. Such photos may have substantially the same time stamp as user's trigger timestamp, which tends to make it easier to match “the moment” the end user really cares about.

### One Embodiment

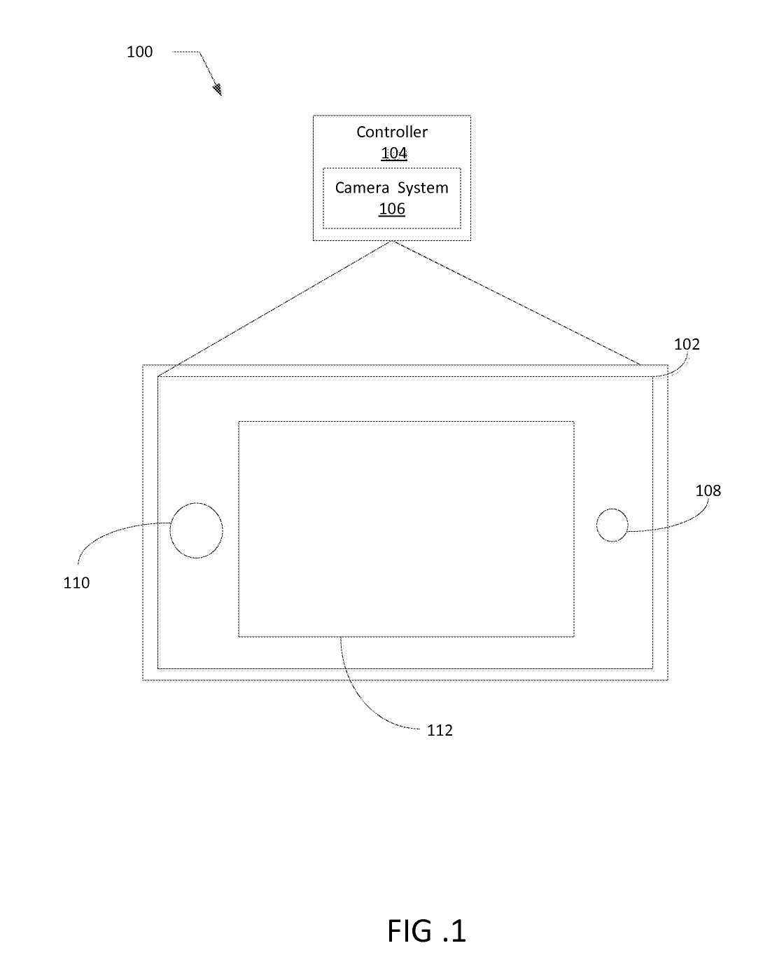

FIG. 1 is one exemplary embodiment (100) of a smart device (e.g., desktop, laptop, tablet, smart phone, digital camera or the like) in which systems, methods and/or techniques of the present application may reside and execute. Device 102 may comprise a controller 104 and a camera system 106. Camera system and/or driver 106 may comprise sufficient software and/or firmware (possibly together with sufficient memory storage) that may control the controller 104 (e.g., as a kernel driver)—possibly in coordination with input from the user and/or applications—to capture and store user photos and/or video, as desired. User's controls may comprise many possible input/output actuators—e.g., possibly including a button/switch 110 to control the operation of the camera and its system to capture image data, as desired by the user. Device 102 may optionally comprise a screen display 112 to display camera system options, recorded images, thumbnail images of recorded images, act as a viewfinder or the like.

It should be appreciated that the controller may be one or more processors and/or processing element distributed within the smart device. In one embodiment, the controller may comprise the kernel driver, the capture engine/pipeline and/or CPU or GPU found in the smart device.

Additionally, camera 108 is able to capture the images and may be implemented with any known camera/image capturing technology—e.g., optical system, CCD or the like. Camera 108 may be placed on device 102 at any position (e.g. front and/or back of the device) as desired by the device designer. Camera 108 may comprise any sufficient optical components (not shown) for either lower-end smart phone/camera use—or high-end digital camera use. In an alternative embodiment, device 102 may be a stand-alone camera (i.e., not a part or subsystem of a smart device, phone or the like). Such a stand-alone camera may comprise a Digital Single-Lens Reflex (DSLR) camera; but may more typically be used in much less expensive cameras that do not have more expensive (e.g., DSLR) capabilities. In another embodiment, the camera system and the associated techniques disclosed herein may apply to any capture device that may supply the digital images, say HDMI capture, screen capture, TV capture, etc.—to other system modules.

As an alternative embodiment, the techniques of the present application may reside remotely from the physical camera—and the camera may take photographs and/or image capture under control of the camera system, as further described herein. In other embodiments, a suitable camera system may be a part and/or subsystem of a smart device, a mobile device, a tablet, a laptop, a desktop and/or a camera. It may suffice for the purposes of the present application that a camera system is capable of affecting a photo sequence mode, as disclosed in many embodiments herein.

In one embodiment, device 102 may comprise multiple modes of operation. For example, device 102 may have a photo mode, a video mode and a photo sequence mode. Photo mode and video mode may be the same typical photo and video modes that are currently provided on most smart and/or mobile devices on the market.

However, there may be other modes (e.g., photo sequence mode) that employ the techniques of the present application, as discussed in detail herein. For merely one example, switching device 102 into a photo sequence mode may be a user-selectable feature (e.g., one amongst others, like photo or video mode). Alternatively, there may be applications (e.g., security applications, DSLR applications, sports image capture applications) that are running on device 102 that may automatically switches device 102 into a photo sequence mode.

Camera System Embodiment

In many smart devices today (or in less expensive versions of digital cameras), it may be the case that the response time of the physical camera is slower than the desired response time of the user, who may be attempting to capture a best image in a scene that is in motion or has other attributes that differ from a photograph taken from—e.g., still life. Alternatively, it may be that the user would like to have a choice of photos—from a set of photos taken from a state of the art, digital camera (e.g., one that has high megapixel, Digital Single Lens Reflex (DSLR) response). In either embodiment, the techniques of the present application may find application for such a user.

In one exemplary use of the present application, it may be desirable to reduce the time to render images captured, and give the user feedback. Thus, it may be desirable to provide a way to fire the progressive events for both the scaled down version of final photo and full resolution photos. These photos may tend to have time stamps close to the user's trigger timestamp, which make it easier to match “the moment” the end user really cares about. In one embodiment, it may be possible to engage in continuous image capture—e.g., capturing images before and/or after the user's click.

In one embodiment, these photos may have different time stamp, but may employ the same mechanism to mark the timestamp—e.g., all times from QPC time. By using the same or similar baseline, an application and/or user may figure out which one better matches the time of the click(s).

Embodiment of Photo Sequencing and Image Buffering

In one embodiment, it may be desirable to provide efficient photo sequence capture and image buffering in order to try to minimize the photo processing delay and improve battery life. For example, the present system may proceed with multiple stages: (1) pre-configuring; (2) pre-buffering in the kernel driver to avoid unnecessary image processing and (3) start and stop photo sequence to trigger the post-processing of a desired (e.g., small) set of photos.

As will be discussed further herein, the present system may reuse a desired number of image buffers that were allocated for pre-processing and employ dynamic buffer allocation to reduce the memory footprint and satisfy a typically high memory requirement for (potentially) unlimited photo sequences. In other systems, it may be desirable to use a parallel accessing capability for scaled-down—as well as full resolution—photos to satisfy both quick rendering and high-quality images generation with both earlier notifications and final photo metadata. In addition, it may be desirable to send out progressive photo sequence events to reduce the multiple photo completion delay and send the photos to the application as long as they are available.

In the course of providing a photo image capture sequence, the present system may define a “timestamp” of when the user has actuated some I/O event. The present system may mark the photos (e.g., scaled-down photos, full resolution photos or the like) with such a timestamp. The timestamp (e.g., the user's photo trigger time) may be employed later by the user to help define the “the moment”—e.g., in order for the user to match against particular photos captured in the sequence. The timestamp and/or the photo trigger time with start photo sequence for selecting proper photos may be passed along in a kernel driver for “moment-based” scenarios. In addition, some embodiments may affect a low cost image capture solution (and implement high-end features, such as “Point and Shoot” camera functionality). This may be affected by off-loading most of the processing on to the system—e.g., the CPU, specific hardware or GPU.

In one embodiment, a present system may provide a way to take photos using cameras on mobile device without losing a moment and at a reduced delay there by helping users to capture the moment the user intended.

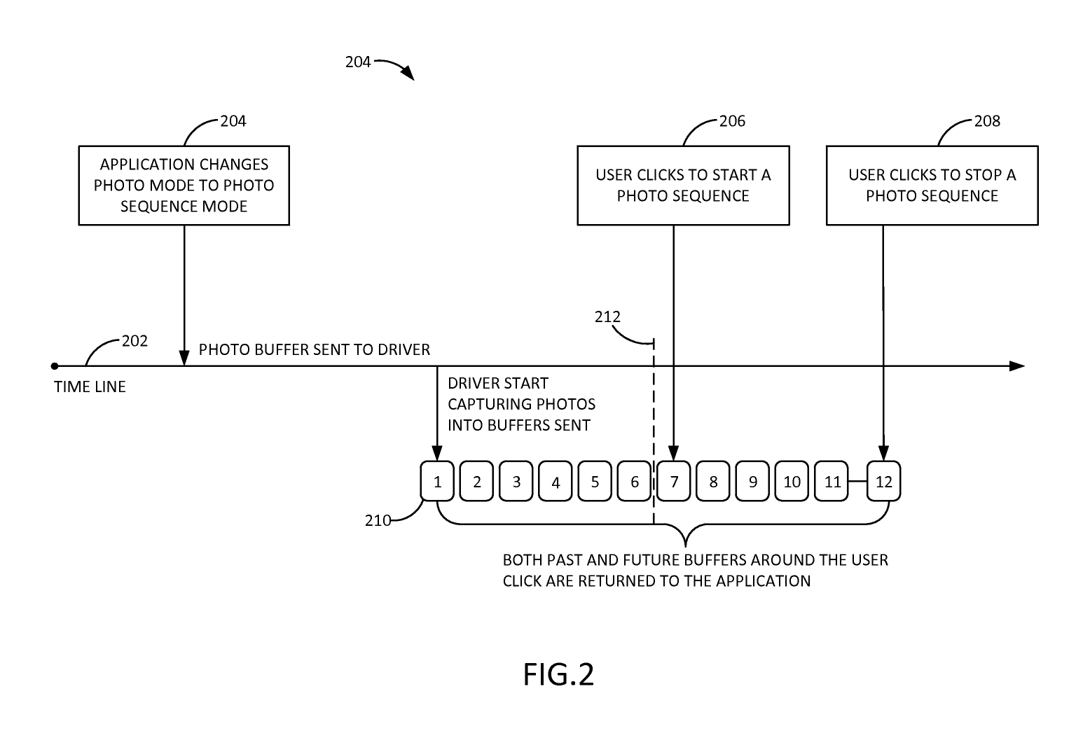

FIG. 2 depicts one embodiment of the photo sequencing mode for present systems and/or methods as made in accordance with the principles of the present application. In photo sequencing mode (200), at some point on time line 202, either the user (and/or an application authorized to implement photo sequencing mode) may actuate an I/O device (e.g., switch, button—physical or soft) or I/O setting—to change and/or set the device into photo sequencing mode. As discussed, changing or setting this mode may implement a number of steps, states and/or conditions.

For example, if desired, the device can start to warm up the camera sensor and prepare it for capturing image data. This pre-click photo stream may help to prepare the sensors, while allocating pre-processing buffers helps to reduce memory allocation delays and pre-capturing helps to ensure that no moment is lost—even before user intends to take a photo. In one embodiment, pre-click image buffers and/or post-click image buffers may be allocated in the pre-processing process.

As some point in time, the device (and/or driver) may start to capture image and/or photo data and send the same into buffers. For example, buffer 210 may represent one image/photo frame as captured. Over time, a set of buffers (designated as “1” through “6” in FIG. 2) may capture, hold and/or store image/photo data—e.g., before the user and/or application has initiated a “click” to intend the paradigm image to be captured.

At 206 as shown, the user and/or application may initiate the “click”—which may commence the photo sequence capture. At 208, the user and/or application may initiate a second, optional, click (and/or other I/O actuation) to stop the photo sequence.

As depicted, line 212 may represent an imaginary point in time that may separate the pre-click image buffers (e.g., taken before the click, or “pre-click”, e.g. buffers labeled “1” through “6”) from post-click image buffers—e.g. taken during the photo sequence mode (e.g., buffers labeled “7” through “12”). In one embodiment, the buffers before line 212 may be recycled and/or re-used. For example, there may be only a desired maximum number of such buffers—and if the device captures image data beyond such maximum number, then the device may start re-using the oldest image buffers, as the current buffer. This set of pre-processing buffers may be implemented in any known data structure to implement this re-use—e.g., a circular buffer or a First In, First Out (FIFO) stack or the like. In one embodiment, after the pre-processing image buffers have been filled, new image data may replace and/or overwrite earlier image buffers. For example, the earliest image buffer may be replaced/overwritten by a currently captured image—and any associated data structure may be updated to identify a new “earliest” image buffer. This process may continue until some point in time—e.g., at the user/application “click” indication, when the system may transition from pre-processing to a photo sequence capture/post-processing mode.

In a final stage, both past and future buffers may be made available to either the user and/or application that is requesting the photo sequence mode. As may be seen, future (or post-click) buffers (e.g., the ones captured after click) may optionally capture image data—e.g., up to a desired maximum buffer limit or unlimited, as desired. Long post-processing time for one frame and multiple frames may be avoided by separating the photo capturing from the photo post processing pipeline. In some embodiments may send progressive photo completions and photo thumbnail events whenever they are available to either the user and/or application initiating photo sequence mode.

In addition, early notification to bypass time consuming large photo post processing and encode operations may help to give better user experience. In one embodiment, such notifications may be sent to the application layer with a scaled down version of the photo. Applications may make use of this scaled down photo to display to users—e.g., before the actual photo is available. Thereby enabling users to preview and select necessary photos. Our solution abstracts the post processing delays involved in photo processing.

Embodiments Using Continuous Photo Capture

In many embodiments, the present system may provide a mechanism to continuously capture photos from the camera sensor. In such an embodiment, the camera stack may pre-program the camera sensor and allocate a set of pre-processing buffers, feed them to the driver, and put the driver in a photo sequence/streaming state. As one initial step, once either the user (or an application capable of switching to photo sequence mode), the device may start to warm up the sensor and prepare the sensor for getting ready to capture image data. In another initial step, the driver may use the allocated pre-processing buffers to capture the photo frames from the camera sensor at a desired frame rate. When the driver runs out of buffers before the user and/or application “clicks” the photo (i.e., indicating to capture the image that is currently present at the time of the click), then the present system may recycle, replace and/or overwrite the oldest buffer in the queue and continue in this fashion—until the “click”.

Facilitating continuous capture in the driver allows scenes to be captured—even before the user intends to take a photo. These pre-captured photos may continue to exist in a pool inside the driver until they are recycled by the driver. In one embodiment, it may desirable to have the driver fill or overwrite these buffers. Buffer pool allocation/recycle/management may be affected by controller and/or capture pipeline.

In another embodiment, it may be desirable to affect a special photo sequence photo trigger—e.g., where the pre-filled buffers are sent out to capture stack. In this case, the driver may only start its expensive ISP processing on the “selected” frames sent to the capture stack. Once the pre-filled buffer is arrived the capture stack, capture stack will immediately send back a new buffer to avoid the glitch for continuous burst photos.

Timestamp Propagation

After the initial setup for photo sequence mode, the present system may provide the camera driver with timestamps for image buffers which may associate the time when the images were captured. In addition, a timestamp may be provided when the user and/or application intends a “click” and/or image capture moment. Camera driver may use this click to return the proper photo frame from the pre-captured photos pool in the driver to the application. For example, for a “Zero Shutter Lag” photo, it may be desirable to pick up the closest frame to the click/trigger time. For a “blink” mode, it may be able to count the history buffers that application wants based on the trigger time.

In one embodiment, due to potential system latency, it may be possible that the current “Take Photo” trigger may arrive at the driver after the intended point of time when the user triggered the “Take Photo” operation. To mitigate this limitation, it may be possible to introduce a trigger time control which may directly inform the driver of the trigger time based on the current system timer to identify the “reference frame”. Such a reference frame may be construed as the frame that is substantially closest to the trigger time in terms of their time stamp.

For one embodiment of the camera driver, the time stamp corresponding to the start of the frame scan may be defined as the frame's time stamp—and possibly not the time stamp corresponding to when the frame is fully scanned. When determining the reference frame, the frame whose time stamp is substantially the closest to the trigger time may be used. If the actual take photo operation arrives so late that the buffer reference frame is overwritten, the driver may employ the available frame whose time stamp is the closest to the trigger time.

PhotoSequence Capture

In one embodiment, the system may return frames before and after the user's click—e.g., in a sequence. This policy tends to guarantee that no moment and/or intended image capture is lost. Since the camera driver is continuously capturing the photos, the camera driver is able to return past and present frames from the pre-captured pool of photos, when the click is sent to the driver. In this embodiment, it may be desirable to add two unique triggers to start and stop the photo capture when the user and/or application wants. This facilitates the camera driver and capture stack to process a small number of photos frames based on the start/stop trigger events. This would tend to use less processing power of the system and may save overall system energy use.

In many of the embodiment, as described herein, a multi-stage approach to photo sequence capture may be desirable—e.g.:
(1) a first stage in which the system may prepare the device and image pipeline and tends to avoid losing any frame by starting the capture before even the user clicks to start capture and prepare the photo sink to reduce the start-up latency;
(2) a second stage in which the system may start the photo sequence capture and tends to delay a battery power-consuming “post process” by processing a small number of frames; and
(3) a third stage, in which the system may stop the photo sequence capture. After this stage and any possible further post-processing, the system may transition back to the first or beginning stage to repeat the process for another image capture.

This multi-stage approach tends to be flexible for application programmers using this feature and use system resources optimally. It will be appreciated the other processing stages may be possible for other embodiments and that these other embodiments are encompassed by the present application.

In another embodiment, it may be possible for the camera system to engage in a photo sequence negotiation phase. In such a case, the photo sequence may have a phase where the application configures as follows:
(1) The number of past frames (history frames) the application/user wants;
(2) Driver responds with the buffer requirements to support the application requested number of history frames; and
(3) Pipeline allocates and sends the requested number of frames to the driver.

When implementing photo sequence mode capture, it may be desirable to determine the approximate raw frames rate so the photo sequence mode can be configured with the proper number of history frames. In addition, when implementing photo sequence mode, it may be desirable to cap the maximum frame rate of the photo capture. This may tend allow that—for those “moment in time” capture scenarios—the number of history frames may be configured appropriately—e.g., based on memory constraints, if the application wishes to capture 1 second worth of past history, it may be desirable to cap the capture rate, so only N number of frames may be employed.

In one embodiment, a Photo Max Frame Rate control may be provided as a configurable setting to the driver, so that the photo capture rate may not exceed this frame rate. If the driver and/or camera sensor can capture faster than this, then the driver might be able to configure itself to provide this capture rate (e.g., typically by dropping frames periodically).

Functional Flow Embodiment

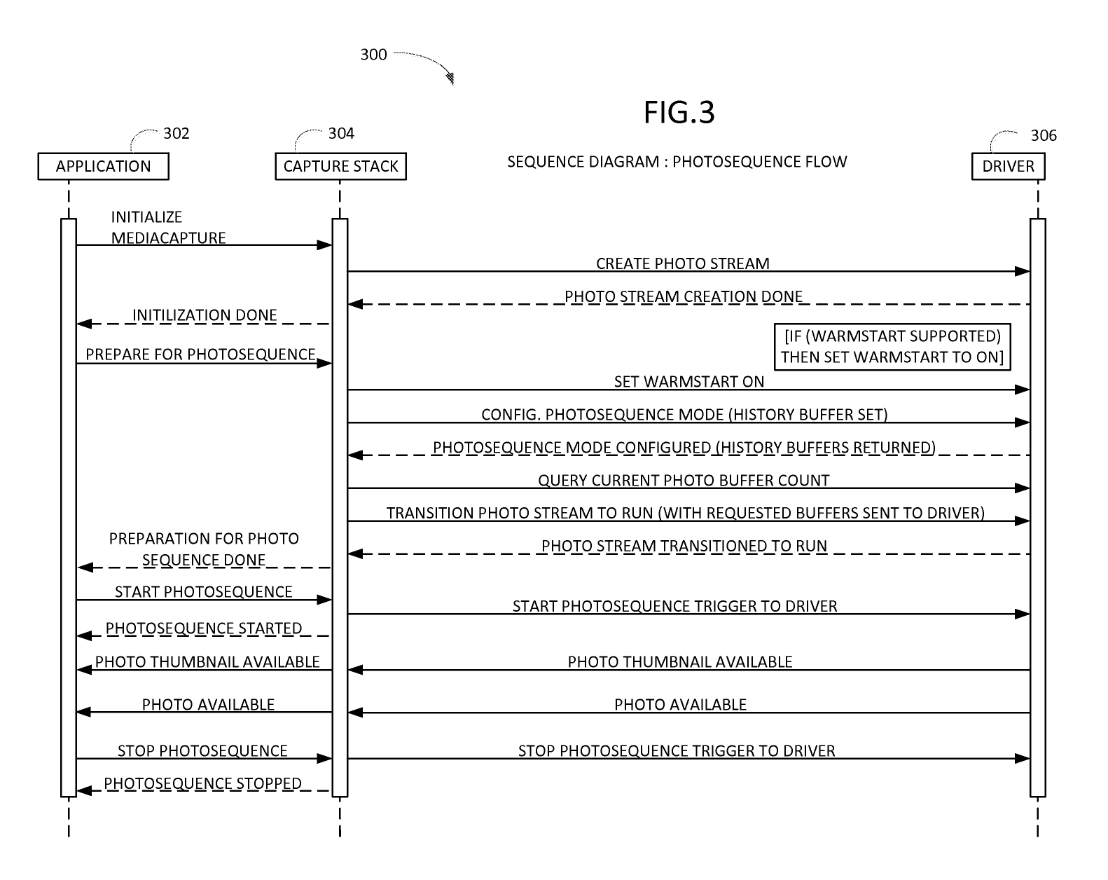

FIG. 3 depicts one embodiment of the present system in flowchart format (300). As may be seen, flowchart 300 depicts the flow of logic by and between: (1) the application calling the camera or photo/image capture system on the device; (2) the capture stack of the camera module and (3) the camera driver for the camera or photo/image capture system on the device.

Application (or user) 302 may upon start-up may initialize a startup routing (e.g., MediaCapture) that may involve Capture Stack 304. For example, this startup may induce driver 306 to create Photo Stream. Once startup/initialization is complete, then the camera system may prepare for photo sequence mode. The camera system may initiate a “Warm Start” procedure, if desired—e.g., one that may start and prepare the camera sensors or any other preparatory processes that may help in capturing timely photo/image capture. In addition, various image buffers may be allocated and readied for image capture. At some point in time, the photo sequence mode may be started and the camera system may proceed as described above

In more particular reference to FIG. 3, the calling application 302 may configure the capture pipeline to output a single photo or a sequence of photos. While in single photo mode, the application may receive one photo closer to the user click. While in the sequence mode, the application may receive a sequence of photos based on the user configuration of the mode. Users may configure the number of photos in the photo sequence—e.g., including the number of past frames in the sequence.

Capture stack 304 may program the camera sensor to output photos at a specific height and width and at a specific rate—e.g., once the photo sequence mode is set, possibly even though the photo trigger does not come in yet. As mentioned, the kernel and user mode objects are created to manage the photos captured. Memory buffers in which to capture the photos may additionally be created and sent to the driver. Driver 306 may feed them into the hardware/firmware and start getting the photos from the sensor. Driver 306 may timestamp each buffer that it fills with a photo. Camera driver may keep moving from one buffer to the other to capture the photos. When the driver reaches the first buffer it filled already, then the driver may recycle the photo with newly arriving photos. The driver may continue this process in a loop. Thus, the driver may continue to pre-capturing the scenes and keep them ready to be returned—e.g. if and/or when the application asks for it.

When user clicks to take photo, capture stack may send a timestamp and a trigger to the camera driver. Camera driver may return the photo from its pool based on the trigger timestamp. If the driver is in a single photo mode, then one photo may be returned. If the driver is in a photo sequence mode, then a sequence of photos may be returned. If the application is configured to get past photos, then driver would return all available past photos with respect to the trigger time and send captured photos as it becomes available to the application—through the capture pipeline—until a stop photo sequence command is sent from the capture stack.

When a photo arrives at the capture pipeline, the system may perform post processing (e.g., de-noising, scaling, zooming, sharpening and encoding). These operations may typically take time in the order of milliseconds. By the time the fully processed high resolution image reaches the application, the time lapsed may be in hundreds of milliseconds. In such instances, a user may notice the delay. To give a better user experience, it may be desirable to implement a notification routing to the application with a scaled down photo, as soon as a photo is received in the pipeline (as discussed further herein). The application may show the scaled down photo to the user while the actual post processing on the photo takes place.

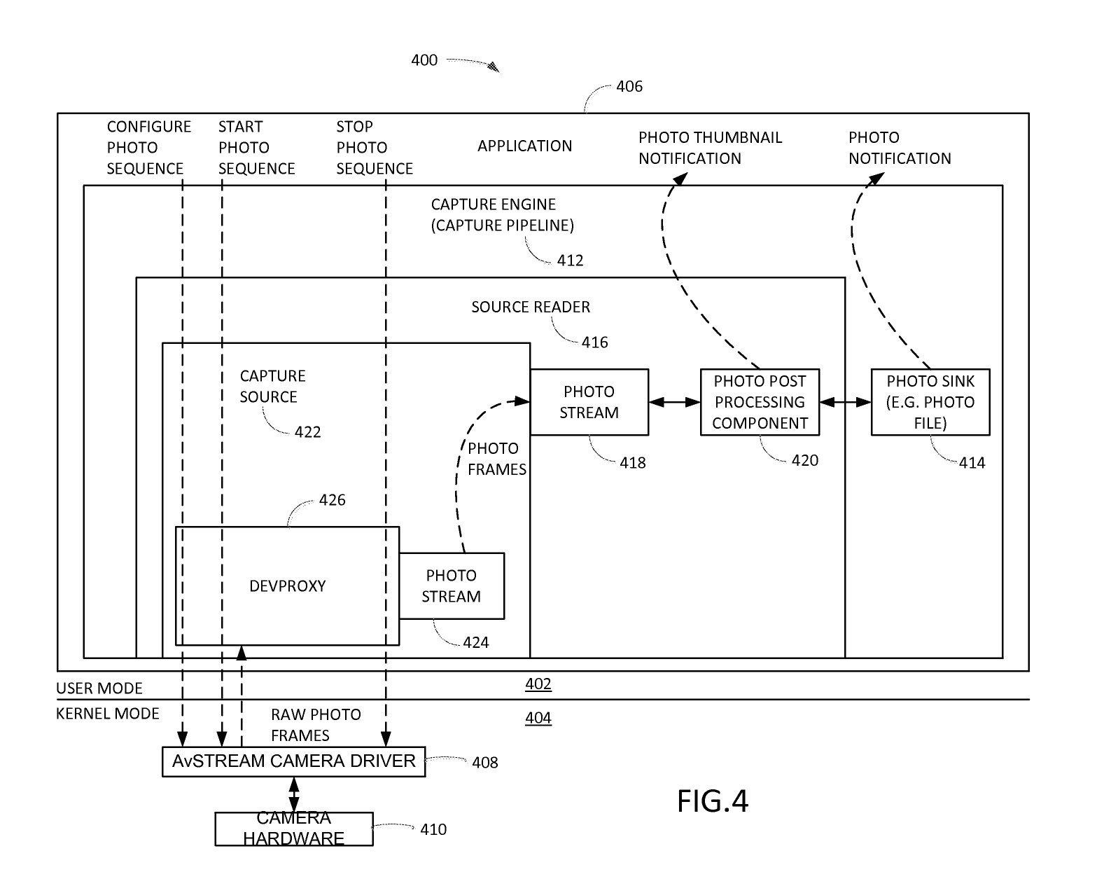

FIG. 4 depicts another embodiment of the present system in a block diagram format. As may be seen, the block diagram may be implemented with a user mode 402 and a kernel mode 404. Kernel mode 404 may receive commands from user mode 402 and be used to control camera system hardware—e.g. camera driver 408 and camera hardware 410. User mode 402 may be initiated by an application 406 that calls, and/or desires access to, the camera system. Application 406 may be initiated by the user and/or another application. A set of commands may be initiated by the user and/or application and/or data returned to the user and/or application—e.g. Configure Photo Sequence, Start Photo Sequence, Stop Photo Sequence, Photo Thumbnail Notification (as described herein) and Photo Notification. Other commands and/or returned data may be possible and the present application encompasses the scope of such other commands and/or returned data.

Application 406 may call other, more specific, functional blocks that are closer to the camera system. For example, capture engine 412, source reader 416, capture source 422 and/or device proxy 426. The following is a paradigm example of an application calling the camera system and initiating a photo sequence mode.

User and/or application 406 may initiate Configure Photo Sequence and send to the camera driver 408. This may initiate the pre-configuration steps—e.g., setting up image buffers, warming up image sensors or the like. Start Photo Sequence may be passed through to camera driver 408 and camera hardware 410—and photo sequence image capture may be started, as described herein. Image data may be captured (substantially continuously) until receipt of Stop Photo Sequence—and the image data may be transferred up from the camera system, kernel mode to the user mode, as shown. In another embodiment, device proxy 426 may allocate image buffers, rather than camera driver 408. It may be possible to avoid extra image data copy when the buffers need to send to a user mode pipeline. In such a case, it may be the camera driver that advocates to device proxy how many buffers are allocated.

Image data may be streamed via photo stream 424 into source reader 416 and to a photo stream module 418 that receives image data in the format of photo and/or image frames. Once the Stop Photo Sequence command has issued photo post-processing 420 may engage in any post-processing desired by the application and/or user.

As discussed further herein, photo thumbnails may be provided to the application and/or user for inspection or the like. Final photo and/or images may be sent to photo sink 414 and a notification of its availability may be sent to the application and/or user.

Early Notification with Photo Thumbnail

As mentioned, in some embodiments, it may be desirable to affect an early notification mechanism—e.g., through which the pipeline calls into the application provided callback function with a scaled down version of the photo. It is possible for applications to display scaled down versions of the image to users—while the heavy, time consuming photo post-processing may take place in the pipeline.

In many embodiments, it may be desirable to return multiple photos together in the photo sequence mode. To reduce the wait time of the multiple photo processing time, it may be possible to allow the pipeline to fire out the progressive photo thumbnails and photo completion events as soon as they are available. These events may have full resolution photos, or scaled down versions of photos—possibly, with a unified device reference time. In such a case, it is possible for applications to match the sequence photos with their corresponding thumbnails properly.

In many photo scenarios, it may be desirable to obtain the photo “taken” notification and the associated thumbnail as soon as possible so the end user/application may be shown the preview of the photo recently captured. It may be desirable to do this without having to wait for the full resolution photo to be decoded, which depending on the resolution may take several hundreds of milliseconds or even several seconds.

### Other Embodiments

In many other embodiments, it may be desirable to affect several other optional features and/or functionality. For example, it may be desirable to allow drivers to continuously capture the raw frames to avoid missing any moment; allow combination of reusing the circular buffer and dynamic buffer allocation to satisfy the high memory usage for unlimited photo sequence scenarios; allow pipeline to perform post processing only on the frames that are delivered to the application; provide the timestamp of the user click to the camera driver to return the proper frames based on different user scenarios.

In addition, it may be desirable to provide mechanism to send both scaled down version of photo and full resolution photo to the application in progressive way; provide a unified timestamp mechanism on photo trigger, photo thumbnails, and full resolution photos to match up the proper “moment” photo whenever they are available.

What has been described above includes examples of the subject innovation. It is, of course, not possible to describe every conceivable combination of components or methodologies for purposes of describing the claimed subject matter, but one of ordinary skill in the art may recognize that many further combinations and permutations of the subject innovation are possible. Accordingly, the claimed subject matter is intended to embrace all such alterations, modifications, and variations that fall within the spirit and scope of the appended claims.

In particular and in regard to the various functions performed by the above described components, devices, circuits, systems and the like, the terms (including a reference to a “means”) used to describe such components are intended to correspond, unless otherwise indicated, to any component which performs the specified function of the described component (e.g., a functional equivalent), even though not structurally equivalent to the disclosed structure, which performs the function in the herein illustrated exemplary aspects of the claimed subject matter. In this regard, it will also be recognized that the innovation includes a system as well as a computer-readable medium having computer-executable instructions for performing the acts and/or events of the various methods of the claimed subject matter.

In addition, while a particular feature of the subject innovation may have been disclosed with respect to only one of several implementations, such feature may be combined with one or more other features of the other implementations as may be desired and advantageous for any given or particular application. Furthermore, to the extent that the terms “includes,” and “including” and variants thereof are used in either the detailed description or the claims, these terms are intended to be inclusive in a manner similar to the term “comprising.”

1. A method for providing a photo sequence mode for a camera system, said camera system comprising a controller, a camera driver, a set of image buffers and an image capture sensor, the method comprising:
allocating a desired number of pre-processing image buffers;
receiving image data from a sensor;
storing said image data into said pre-processing image buffers;
re-using said pre-processing image buffers when said desired number of pre-processing image buffers have been filled;
receiving a click indication; and
storing image data into post-click image buffers after receiving said click indication.

2. The method of claim 1 wherein said camera system is a part of one of a group, said group comprising: a smart device, a mobile device, a tablet, a laptop, a desktop and a camera.

3. The method of claim 1 wherein said method further comprises:
receiving an indication to place said camera system into photo sequence mode.

4. The method of claim 3 wherein receiving an indication to place said camera system into photo sequence mode further comprises:
receiving an indication from one of a group, said group comprising: a user and an application capable of accessing said camera system.

5. The method of claim 1 wherein said method further comprises:
warming up the sensors of said camera.

6. The method of claim 1 wherein allocating a desired number of pre-processing image buffers further comprises:
setting up said desired number of pre-processing image buffers into a data structure, said data structure denoting an earliest image buffer in time.

7. The method of claim 6 wherein said data structure comprises one of a group, said group comprising: a circular buffer and a FIFO structure

8. The method of claim 6 wherein re-using said pre-processing image buffers further comprises:
overwriting said earliest image buffer with substantially current captured image data; and
identifying a new earliest image buffer within said set of pre-processing image buffers.

9. The method of claim 1 wherein receiving a click indication comprises one of group, said group comprising: receiving a click indication from a user of said camera system and receiving a click indication from an application capable of accessing said camera system.

10. The method of claim 1 wherein receiving a click indication further comprises:
receiving a command to capture the image data by said camera system substantially at the same time as the receipt of said click indication.

11. The method of claim 1 wherein receiving a click indication further comprises:
providing time stamps for image buffers, said time stamps associated with the time that said images stored in said image buffers were captured.

12. The method of claim 11 wherein said method further comprises:
returning a set of images, said images comprising time stamps substantially contemporaneous with said click indication.

13. The method of claim 12 wherein returning a set of images further comprises:
returning a set of thumbnail images associated with set of images.

14. A camera system comprising:
a controller;
a camera, said camera comprising an optical system, an image sensor;
a camera driver, said camera driver executing on said controller and capable of controlling said camera; and
further wherein said camera driver capable of:
allocating a desired number of pre-processing image buffers;
receiving image data from a sensor;
storing said image data into said pre-processing image buffers;
re-using said pre-processing image buffers when said desired number of pre-processing image buffers have been filled;
receiving a click indication; and
storing image data into post-click image buffers after receiving said click indication.

15. The camera system of claim 14 wherein said camera system comprises one of a group, said group comprising: a smart device, a mobile device, a tablet, a laptop, a desktop and a camera.

16. The camera system of claim 15 wherein said camera driver further capable of:
receiving an indication to place said camera system into photo sequence mode.

17. The camera system of claim 16 wherein said camera driver further capable of:
setting up said desired number of pre-processing image buffers into a data structure, said data structure denoting an earliest image buffer in time;
overwriting said earliest image buffer with substantially current captured image data; and
identifying a new earliest image buffer within said set of pre-processing image buffers.

18. The camera system of claim 17 wherein said camera driver further capable of
returning a set of images, said images comprising time stamps substantially contemporaneous with said click indication.

19. A smart device comprising:
a controller;
a camera, said camera comprising an optical system, an image sensor;
a camera driver, said camera driver executing on said controller and capable of controlling said camera; and
further wherein said camera driver capable of:
allocating a desired number of pre-processing image buffers;
receiving image data from a sensor;
storing said image data into said pre-processing image buffers;
re-using said pre-processing image buffers when said desired number of pre-processing image buffers have been filled;
receiving a click indication; and
storing image data into post-click image buffers after receiving said click indication.

20. The smart device of claim 15 wherein said camera driver further capable of:
receiving an indication to place said camera system into photo sequence mode.
